(19) United States
(12) Patent Application Publication
(10) Pub. No.: US 2002/0133521 A1
(43) Pub. Date: Sep. 19, 2002

(54) System and method for text delivery

(76) Inventors: Gregory A. Campbell, San Francisco, CA (US); Steven P. Lum, San Francisco, CA (US)

Correspondence Address: SKJERVEN MORRILL LLP, 25 METRO DRIVE, SUITE 700, SAN JOSE, CA, 95110, US

(21) Appl. No.: 09/809,117

(22) Filed: Mar. 15, 2001

(51) Int. Cl. G06F 17/21

(52) U.S. Cl. 707/526; 707/530

(57) ABSTRACT

A method and system are provided for facilitating a user-configurable delivery and display of a body of text to a user (e.g., person) in a “stacked” manner. The method includes accessing a document comprising a body of text interspersed with terminal characters and which can be separated into a sequence of text groupings. The method also includes retrieving an initial text grouping from the document, setting the initial text grouping as a present text grouping, and displaying the present text grouping to a user for a respective display duration, wherein the display duration is configurable by the user. Responsive to not retrieving a terminal character, the method further includes retrieving an immediately subsequent text grouping from the document, setting the immediately subsequent text grouping as the present grouping, and repeating the displaying the present text grouping, retrieving an immediately subsequent text grouping, and setting the immediately subsequent text grouping until a terminal character is retrieved. The system includes a text player operable to retrieve a text grouping from a document source and display the text grouping for a respective display duration configurable by a user. The text player is further operable to, in response to not retrieving a terminal character, retrieve an immediately subsequent text grouping from the document source and display the immediately subsequent text grouping in the display for a respective display duration by replacing the previously displayed text grouping

### BACKGROUND

1. Field

The present invention relates generally to the display of data on a computer screen, and in particular, to a system and method for text delivery.

2. Description of the Related Art

In recent times, a significant amount of information has been made readily available (e.g., via the Internet) to anyone having access to one or more of a variety of electronic devices with visual display capability, such as, for example, personal computers, cellular telephones, smart telephones, pagers, personal digital assistants (PDAs), and the like. The way in which text is presented on these electronic devices, however, has not changed significantly from conventional print form. That is, the display of text on computer screens and other electronic devices have largely been provided in a conventional layout where a large amount of text is presented simultaneously in a sentence and paragraph structure.

This layout has proved problematic in displaying text in small or limited display areas. Various methods of text display have been developed to cope with this issue. Text scrolling and ticker tape display are two such methods. Another method that is utilized on the Internet is the “chunking” or the assembly of information into content bites connected by a hyperlink. These methods generally fail to address the issues related to the delivery and presentation of text without significant loss of speed or comprehension.

In the late 1930's, L. C. Gilbert, an ophthalmologist, developed the origins of a text display method called rapid serial visual presentation (RSVP). Gilbert wanted to remove the physical inefficiencies inherent in the way humans read printed text. Whether reading left to right, or top to bottom, the eyes follow a progression of words or characters in the act of reading. The physical movement of the eyes is known as saccadic eye movement. Gilbert recognized the physical patterns associated with saccadic eye movement.

Gilbert observed that when reading, the eye focuses on a word or character, and when sufficient processing has occurred to comprehend the meaning of the word or character, the eye shift's focus to the next word or character to begin the process again. Gilbert found this shifting of focus from one word or character to the next to be very inefficient. Gilbert concluded that the eye spends nearly as much time in the focus-refocus process as it does in the comprehension process. Gilbert also concluded that following a sentence across a page is a task for which the human eye is ill-suited.

Gilbert developed RSVP as a solution to the perceived problems associated with the manner in which humans read printed text. Instead of presenting words in the conventional style of a linear progression on a two-dimensional plane, RSVP stacks the words and presents them singularly as if from a z-axis or third dimension. By delivering the words to the eye from this third dimension, Gilbert eliminated the saccadic eye movement required when the eye had to move to the words or characters.

When Gilbert first experimented with RSVP in 1939, film was the most advanced technology available. Gilbert used film to create cine-loops of various text material with which to experiment. His work with these cine-loops validated his assumptions regarding text delivery and the experiments showed that text could be read with a high degree of both speed and comprehension using RSVP. At that time, Gilbert's work generated some interest in academic circles, but the idea languished and eventually fell into obscurity.

Interest in Gilbert's RSVP idea emerged again in the 1970's. Numerous studies were conducted by psychologists and learning behaviorists who again validated the effectiveness of RSVP as a means of reading text. At this time, computers were in their infancy, but were used as a vehicle to conduct more sophisticated RSVP experiments, and the scientists were able to fine-tune Gilbert's original theories regarding RSVP.

The sophisticated RSVP experiments generally involved minor variations to the RSVP developed by Gilbert. The requirement to obtain valid test results and the general complexity with computer programming during that period made it necessary for the scientists to control the RSVP. This included controlling the variations to RSVP because of the general need for reprogramming the computers used in the experiments. The test subjects were not able to vary the RSVP to account for differences in physical and intellectual characteristics.

What is needed is the delivery of information formatted for a small window size, under control of the information receiver (e.g., the reader), that enables the reader to retain equal or better comprehension.

### SUMMARY

The present invention provides a system and method for user-configurable delivery and display of a document's contents in a “stacked” manner (e.g., through a third dimension) on computer screens and electronic devices (e.g., LED, LCD, etc.). A text player application presents the document contents in the stacked manner for reading by the user. In the stacked manner, the document content is presented for reading to the user in small groupings, each of which is separately displayed for a respective interval or duration (e.g., one word or three words at a time). The user is able to control the length of time each grouping is displayed.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

In one embodiment, a method for displaying text includes: accessing a document having a body of text interspersed with terminal characters and which can be separated into a sequence of text groupings; retrieving an initial text grouping from the document; setting the initial text grouping as a present text grouping; displaying the present text grouping to a user for a respective display duration, wherein the display duration is configurable by the user; responsive to not retrieving a terminal character, retrieving an immediately subsequent text grouping from the document; setting the immediately subsequent text grouping as the present grouping; and repeating the displaying the present text grouping, retrieving an immediately subsequent text grouping, and setting the immediately subsequent text grouping until a terminal character is retrieved.

In another embodiment, a method includes: responsive to a command received from a user, retrieving a body of text from a document, the body of text having a sequence of textual elements, wherein at least a portion of the textual elements are terminal characters; dividing the sequence of textual elements into strings of sequential text groupings, wherein each string ends with a terminal character, and each text grouping having at least one textual element; and for each string, separately displaying to the user for a respective display period each text grouping of the string in sequence until the terminal character of the string is reached, wherein a duration of display periods is configurable by the user.

In still another embodiment, a method for retrieving text for display on an electronic device includes: receiving a data stream from a document source, the data stream having a body of text interspersed with terminal characters and which can be separated into a sequence of text groupings; generating an initial text grouping from the received data stream; setting the initial text grouping as a present text grouping; displaying the present text grouping to a user for a respective display duration on an electronic device's display; responsive to not receiving a terminal character, generating an immediately subsequent text grouping from the data stream; setting the immediately subsequent text grouping as the present text grouping; and repeating the displaying the present text grouping, generating an immediately subsequent text grouping, and setting the immediately subsequent text grouping until a terminal character is received.

In yet another embodiment, a text delivery system includes a text player operable to retrieve a text grouping from a document source and display the text grouping in a display for a respective display duration configurable by a user. The text player is further operable to, in response to not retrieving a terminal character, retrieve an immediately subsequent text grouping from the document source and display the immediately subsequent text grouping in the display for a respective display duration by replacing the previously displayed text grouping.

In a further embodiment, a computer-readable storage medium has stored thereon computer instructions that, when executed by a computer, cause the computer to: access a document having a body of text interspersed with terminal characters and which can be separated into a sequence of text groupings; retrieve an initial text grouping from the document; set the initial text grouping as a present text grouping; display the present text grouping to a user for a respective display duration, wherein the display duration is configurable by the user; in response to not retrieving a terminal character, retrieve an immediately subsequent text grouping from the document; set the immediately subsequent text grouping as the present text grouping; and repeat the display the present text grouping; retrieve an immediately subsequent text grouping, and set the immediately subsequent text grouping until a terminal character is retrieved.

In still a further embodiment, a computer-readable storage medium has stored thereon computer instructions that, when executed by a computer, cause the computer to: in response to a user command, retrieve a body of text from a document, the body of text having a sequence of textual elements, wherein at least a portion of the textual elements are terminal characters; divide the sequence of textual elements into strings of sequential text groupings, wherein each string ends with a terminal character, and each text grouping having at least one textual element; and for each string, separately display to a user for a respective display period each text grouping of the string in sequence until the terminal character of the string is reached, wherein a duration of display periods is configurable by a user.

In yet a further embodiment, a text player system includes computer instructions that, when executed by a computer, cause the computer to: receive a data stream from a document source, the data stream having a body of text interspersed with terminal characters and which can be separated into a sequence of text groupings; generate an initial text grouping from the received data stream; set the initial text grouping as a present text grouping; display the present text grouping to a user for a respective display duration on an electronic device's display; responsive to not receiving a terminal character, generate an immediately subsequent text grouping from the data stream; set the immediately subsequent text grouping as the present text grouping; and repeat the display the present text grouping, generate an immediately subsequent text grouping, and set the immediately subsequent text grouping until a terminal character is received.

These and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

FIG. 1 illustrates an exemplary screen display window for a text player application, according to an embodiment of the present invention.

FIG. 2 illustrates another exemplary screen display window for the text player application, according to another embodiment of the present invention.

FIGS. 3A, 3B, and 3C illustrate an exemplary sequence for a single textual element stacked display, according to an embodiment of the present invention.

FIGS. 4A, 4B, and 4C illustrate an exemplary sequence for a three-textual element stacked display, according to an embodiment of the present invention.

FIGS. 5A, 5B, 5C, and 5D illustrate an exemplary sequence for a three-textual element stacked display, according to another embodiment of the present invention.

FIG. 6 illustrates an exemplary stacked display and an associated conventional display, according to an embodiment of the present invention.

FIG. 7 illustrates an exemplary environment in which a text delivery system, according to an embodiment of the present invention, may operate.

FIG. 8 illustrates another exemplary environment in which the text delivery system, according to another embodiment of the present invention, may operate.

FIG. 9 is a flow chart of an exemplary method for delivering and displaying text, according to an embodiment of the present invention.

FIG. 10 is a flow chart of another exemplary method for delivering and displaying text, according to an embodiment of the present invention.

### DETAILED DESCRIPTION

A text delivery system and corresponding methods, according to an embodiment of the present invention, facilitates a user-configurable delivery and display of a body of text to a user (e.g., person) in a “stacked” manner. The body of text (e.g., a document) contains a number of components (e.g., words). The system and methods stack the components making up the body of text (for example, one behind another) and separately present each stacked component in sequence in a display for viewing by the user. The user may control the parameters associated with the delivery and display of the body of text.

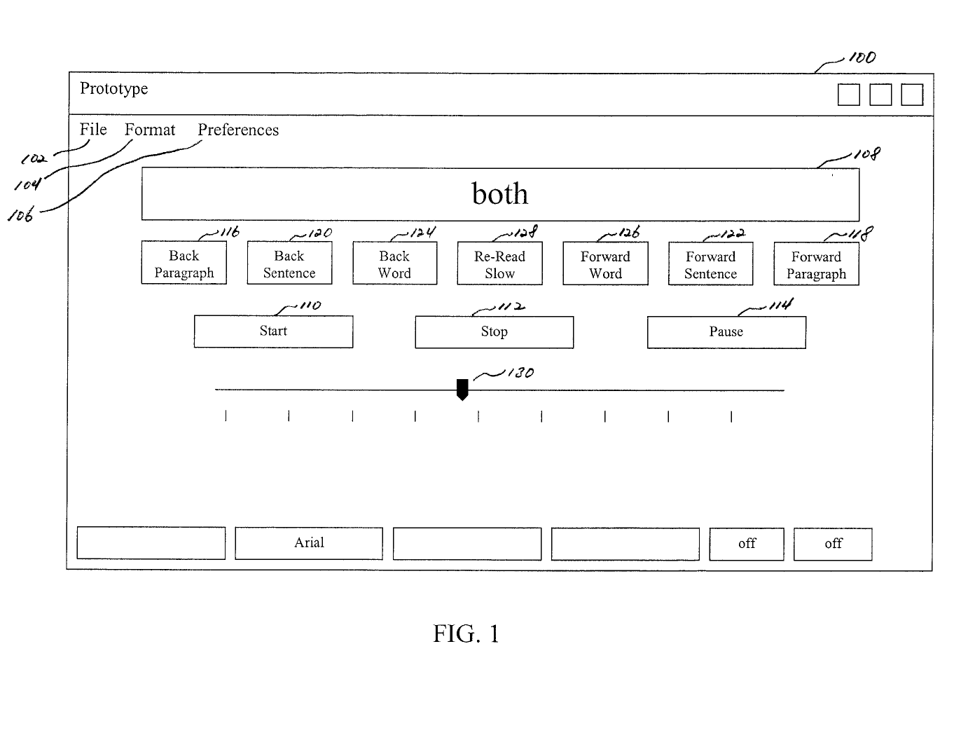

Embodiments of the present invention are understood by referring to FIGS. 1-10 of the drawings. Throughout the drawings, components that correspond to components shown in previous figures are indicated using the same reference numbers.

Nomenclature

The detailed description that follows is presented largely in terms of processes and symbolic representations of operations performed by conventional computers. A computer may be any microprocessor or processor (hereinafter referred to as processor) controlled device, including terminal devices, such as personal computers, workstations, servers, clients, mini-computers, main-frame computers, laptop computers, a network of one or more computers, mobile computers, portable computers, handheld computers, palm top computers, set top boxes for a TV, interactive televisions, interactive kiosks, personal digital assistants, interactive wireless devices, mobile browsers, or any combination thereof. The computer may possess input devices such as, by way of example, a keyboard, a keypad, a mouse, a microphone, or a touch screen, and output devices such as a computer screen, display, printer, or a speaker. Additionally, the computer includes memory such as a memory storage device or an addressable storage medium.

The computer may be a uniprocessor or multiprocessor machine. Additionally, the computer, and the computer memory, may advantageously contain program logic or other substrate configuration representing data and instructions, which cause the computer to operate in a specific and predefined manner as, described herein. The program logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like.

The program logic conventionally includes the manipulation of data bits by the processor and the maintenance of these bits within data structures resident in one or more of the memory storage devices. Such data structures impose a physical organization upon the collection of data bits stored within computer memory and represent specific electrical or magnetic elements. These symbolic representations are the means used by those skilled in the art to effectively convey teachings and discoveries to others skilled in the art.

The program logic is generally considered to be a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, records, files, or the like. It should be kept in mind, however, that these and some other terms should be associated with appropriate physical quantities for computer operations, and that these terms are merely conventional labels applied to physical quantities that exist within and during operation of the computer.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general purpose computing machines or devices may be used with programs constructed in accordance with the teachings described herein. Similarly, it may prove advantageous to construct a specialized apparatus to perform the method steps described herein by way of dedicated computer systems with hard-wired logic or programs stored in non-volatile memory, such as read-only memory (ROM).

Text Player Application

Referring now to the drawings, FIG. 1 illustrates an exemplary screen display window 100 for a text player application, according to an embodiment of the present invention. The text player application may be a software program configured to execute on, for example, a computer or other electronic device. The text player application may generate screen display window 100 on a display device coupled to the computer or electronic device. In particular, screen display window 100 provides an interface through which a user can receive and view, for example, contents of a document delivered by the text player application, as well as control the operation of the text player application.

In one embodiment, a user specifies a “document,” for example, through screen display window 100, for processing. The text player application generally functions to process (e.g., parse) the contents of the specified document, and present the document contents to the user through screen display window 100. “Document” generally refers to a collection of characters. For example, the document may be a text file, a Microsoft Word® file, an HTML file, a data stream, and the like, which has contents that may be displayed and viewed by the user.

The text player application identifies one or more “textual elements” contained in the specified document. “Textual element” generally refers to a word or character (e.g., Chinese, Japanese, etc.) that has some meaning by itself (as opposed to a mere letter such as “D” which generally means nothing standing alone). Textual element may or may not refer to a “terminal character,” which can be a comma, period, paragraph break, page break, end of file, and the like, which signifies the end of a “string.” In one embodiment, a textual element may be a word and a punctuation character (i.e., comma, period, etc.) immediately following the word. In one embodiment, a terminal character may also be an indicator identifying the last word or character to display.

“String” generally refers to a sequence of textual elements ending with a terminal character, and which can be broken down or divided into one or more “text groupings.” A user may define each string to be a phrase (ending with a textual element, comma, colon, semicolon, or other punctuation character), a sentence (ending with a period), a paragraph (ending with a paragraph break), etc. The text player application may also define each string in processing the document. For example, the text player application may partition the document contents into one or more strings as the application processes a document. “Text grouping” generally refers to one or more textual elements grouped together for purposes of display through screen display window 100. For example, the text player application displays text groupings, one at a time, in screen display window 100. The user may configure (e.g., set or adjust) the number of textual elements to be presented in each text grouping. For example, the user may select one-word groupings or three-word groupings, as further described herein.

In one embodiment, the text player application generally functions to display text groupings (e.g., the contents of a document, the contents of a text file, the contents of a data stream, etc.) to a user in a manner that eliminates the need for the user to read the text groupings in the conventional way—i.e., by following a progression of words or characters, for example, from left to right, and top to bottom on a computer screen. Rather, the text player application delivers and displays to the user a sequence of text groupings which conceptually are “stacked” along an axis that extends out from screen display window 100 to the user. For example, the text player application displays a present text grouping, and subsequently, displays an immediately following text grouping by replacing the present text grouping in screen display window 100 with the following text grouping. Furthermore, the delivery and display of the sequence of text groupings is under the control of the user.

In one embodiment, the document may also contain or be associated with other data, such as, by way of example, images, graphs, tables, headings, icons, audio, multimedia, and the like. These other data may not be presentable through screen display window 100 as a text grouping. The text player application may present the data that is not capable of being displayed through screen display window 100 through another output mechanism to the user. For example, audio content may be presented at the appropriate time to the user through a sound card and speakers. Images, graphs, and tables may be displayed at the appropriate time through another window or display on the computer. In another embodiment, the text player application may omit or disregard the document contents that are not presentable through screen display window 100.

Referring again to FIG. 1, screen display window 100 includes menu selections and button icons that enable a user to control the operation of the text player application. As depicted, screen display window 100 comprises a file menu 102, a format menu 104, a preferences menu 106, a display area 108, a start button icon 110, stop button icon 112, pause button icon 114, back paragraph button icon 116, a forward paragraph button icon 118, a back sentence button icon 120, a forward sentence button icon 122, a back word button icon 124, a forward word button icon 126, a re-read slow button icon 128, and a tempo control 130. Text groupings of a document are presented to a user in display area 108. The user may access the menu selections 102, 104, and 106, activate the button icons 110, 112, 114, 116, 118, 120, 122, 124, 126, and 128, and adjust tempo control 130 using an input device (such as, by way of example, a mouse or the like) to control the presentation of text groupings in display area 108.

File menu 102 button operates to display a menu containing one or more file or document operations. There may be options to open, select, or specify a document, close a document, book mark a location in a document, go to a previously book marked location in a document, or exit the text player application. In one embodiment, selecting an item from the displayed menu may display one or more additional menus, for example, wizards, that facilitate the selected function.

For example, a selecting the option to open a document may display a wizard through which a user can specify a document identification (e.g., URL, filename, etc.) for a document. The text player application may retrieve the contents of the specified document in preparation for displaying the text groupings in display area 108 of screen display window 100. In another example, selecting the option to book mark a location in a document may display the document's contents in a window along with a cursor. A user can then use the cursor to tag or identify certain portions of the document for retrieval. Subsequently, the user can select the option to go to a previously book marked location in the document.

Format menu 104 operates to display a menu through which a user can specify the “look-and-feel” of the text player application, and in particular, screen display window 100. Selecting format menu 104 may display a window through which a user can select or specify the font, font size, color, bold, italic, and the like.

Preferences menu 106 operates to display a menu through which a user can specify and save his or her preferences regarding the operation of the text player application. Selecting preferences menu 106 may display one or more windows through which a user can specify a speed, minor delay, major delay, sentence stop, paragraph stop, chapter stop, speed of the re-read function, etc. For example, through the speed option, a user may be able to specify the speed or tempo of the text player application. The minor delay and major delay options enable a user to specify one or more punctuation marks the text player application is to treat as minor delays or major delays, respectively. In another embodiment, the user may specify the length of delay associated with the minor delay and major delay. The stop options enable a user to specify whether or not the text player application is to stop and wait for a user prompt (e.g., key press) after delivering each sentence, paragraph, chapter, etc., but before continuing with the delivery of the document contents. In another embodiment, the user may specify a length of time for one or more stop options. The specified length of time may indicate a time duration the text player application is to stop before continuing with the delivery of the document contents.

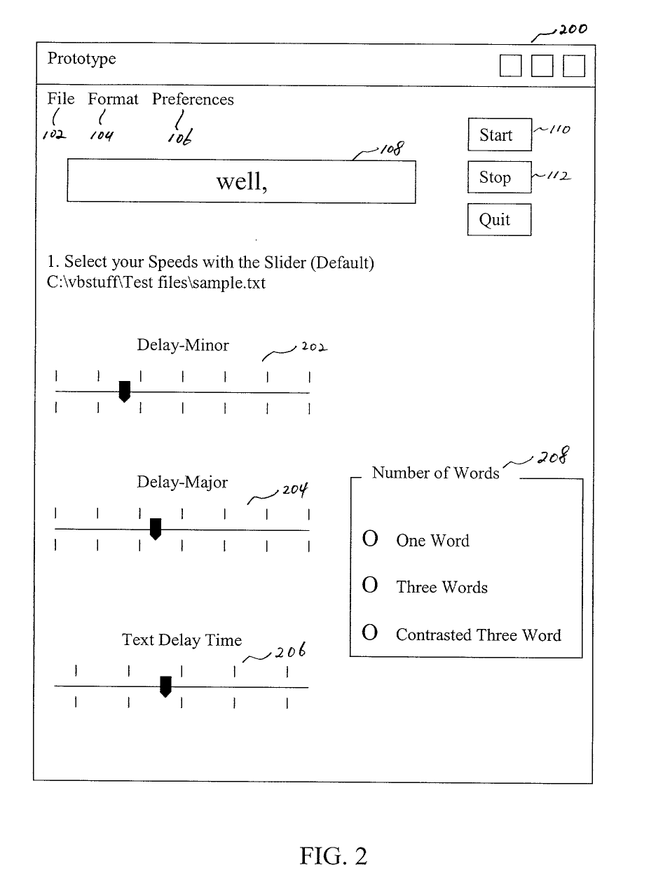

Those of ordinary skill in the art will realize that the options and features disclosed herein may also be provided to users by other mechanisms than those specified in the disclosure. Furthermore, one or more of the options and features may be omitted in some implementations without detracting from the essence of the invention. For example, the option to specify the speed or tempo of the text player application may be provided through one or more slide controls in a window as depicted in FIG. 2.

Display area 108 displays the contents of a document specified by a user. In one embodiment, the text player application displays a sequence of text groupings in display area 108. The text player application obtains one or more textual elements from the user-specified document to form a text grouping. The text player application sets a text grouping as a present text grouping. The text player application displays the present text grouping in substantially the center of display area 108. As illustrated in FIG. 1, the present text grouping, “both,” is currently displayed in display area 108. Here, the text grouping “both” is also a textual element (e.g., a word).

Start button icon 110 operates to start the text player application. The start button 110 operates much like the start button on a standard cassette or compact disk player. In particular, in response to a user's “pushing” or activating start button icon 110, the text player application starts to process the textual elements contained in the user specified document and displays the textual elements in display area 108 as a sequence of text groupings. Activating start button icon 110 causes the text player application to start processing the document's contents from a current position in the document. The current position identifies a textual element in the document from which the text player application is to start or resume processing. The text player application updates the current position in the document to be a textual element that is immediately subsequent to the most recently processed textual element in the document. In another embodiment, the current position may be the most recently processed textual element in the document. In this case, the text player application may resume processing with a textual element immediately subsequent to the current position.

For example, the first time start button icon 110 is activated, the current position in a document may be the first textual element in the document. Subsequently, the text player application may process the first ten textual elements before the text player application ceases processing, for example, through a “stop” command. The text player application may “mark” its place in the document by, for example, identifying the last or most recently processed textual element (i.e., the tenth textual element) as the current position in the document. In response to receiving a subsequent “start” command, the text player application may resume processing at the identified current position (i.e., the tenth textual element).

Stop button icon 112 operates to stop the display of successive text groupings in display area 108. Activating stop button icon 112 operates to terminate the text delivery associated with the currently processed document. In one embodiment, the text player application may prompt the user to determine if the user wants to close the document. The text player application may also prompt the user to determine if the user wants to mark the position in the document that was last or most recently processed. The text player application may further prompt the user to determine if the user wants to save some or all of the preferences associated with the document and the delivery of the document's contents.

Pause button icon 114 operates to pause the display of successive text groupings in display area 108. Activating pause button icon 114 suspends the text delivery associated with the currently processed document. The text player application does not close the document and thus, preferences associated with the document and the and the delivery of the document's contents are preserved.

Back paragraph button icon 116 generally functions to permit the user to backtrack to the beginning of an immediately preceding paragraph in the document. Activating back paragraph button icon 116 operates to reposition a pointer or cursor in the document to a new position at a first textual element in the paragraph immediately preceding the paragraph from which a text grouping is currently displayed. The pointer identifies the current position in the document. The text player application may then create a text grouping beginning at the textual element identified at the new position for the pointer, and display the text grouping in display area 108.

Forward paragraph button icon 118 generally functions to permit the user to move ahead to the beginning of an immediately following paragraph in the document. Activating forward paragraph button icon 118 operates to reposition the pointer in the document to a position at a first textual element in a paragraph immediately following the paragraph from which a text grouping is currently displayed. The text player application may then create a text grouping beginning at the textual element identified at the new position for the pointer, and display that text grouping in display area 108.

Back sentence button icon 120 and forward sentence button icon 122 generally function in a manner similar to back paragraph button icon 116 and forward paragraph button icon 118, respectively, except that, instead of moving to a position at the beginning of the immediately preceding or immediately following paragraph, the pointer is re-positioned at the beginning of the immediately preceding or immediately following sentence, respectively. For example, activating back sentence button icon 120 operates to reposition the pointer to a new position at a first textual element in the immediately preceding sentence. Likewise, activating forward sentence button icon 122 operates to reposition the pointer to a position at a first textual element in an immediately following sentence. The text player application may then create a text grouping beginning at the textual element identified at the new position for the pointer, and display that text grouping in display area 108.

Back word button icon 124 generally functions to permit the user to backtrack to an immediately preceding word in the document. Activating back word button icon 124 operates to reposition the pointer to a position at an immediately preceding textual element in the document. Forward word button icon 126 generally functions to permit the user to proceed to an immediately following word in the document. Activating forward word button icon 126 operates to reposition the pointer to a position at an immediately following textual element in the document. The text player application may then create a text grouping beginning at the textual element identified at the new current position, and display the text grouping in display area 108.

Re-read slow button icon 128 generally functions to permit the user to slow the delivery of specific content contained in the document. For example, during the course of reading a document using the text player application, the user may come across important and/or difficult material. The user may then use one or more of the return button icons (i.e., back paragraph button icon 116, back sentence button icon 120, or back word icon 124) to backtrack to the beginning of the important and/or difficult material. Using the return button icons to backtrack establishes a new position for the pointer at the document. The backtracked material is the document contents (i.e., the textual elements) from the new pointer position to the old current position in the document. Afterwards, the user can activate re-read slow button icon 128 to re-read the important and/or difficult material (the backtracked material) at a slower speed.

In one embodiment, each activation of re-read slow button icon 128 reduces the speed of the delivery for the backtracked material to one-half of the previous delivery speed. For example, if the text player application delivered the text groupings at a delivery speed of approximately 500 text groupings per minute, then activating re-read slow button icon 128 once causes the text player application to deliver the backtracked material at a delivery speed of approximately 250 text groupings per minute. Once the backtracked material is delivered, the text player application may resume delivering the text groupings at the delivery speed of 500 text groupings per minute. Thus, in one embodiment, activating re-read slow button icon 128 does not re-set or alter the delivery speed parameters for the non-backtracked material in the document. Activating re-read slow button icon 128 a second time causes text player application to deliver the backtracked material at a delivery speed of approximately 125 text groupings per minute.

In one embodiment, the text player application may provide an option, for example, through screen display window 100, which enables a user to preserve or save the re-read slow selections for subsequent readings of the backtracked material. For example, if the user activates re-read slow button icon 128 to slow the delivery speed to re-read specific backtracked material (e.g., a paragraph), this re-read slow command can be saved to memory. The text player application may save in memory information necessary to preserve the re-read slow selection, such as, by way of example, identification to identify the backtracked material, the delivery speed, and the like. Any subsequent readings of the backtracked material may cause the text player application to deliver the backtracked material at the preserved delivery speed (the re-read delivery speed).

Tempo control 130 generally functions to permit the user to control the tempo or delivery speed of the text player application. For example, moving tempo control 130 to the left may decrease the delivery speed, while moving tempo control 130 to the right may increase the delivery speed. The delivery speed may be a factor in determining the rate at which the text player application delivers and displays a sequence of text groupings in display area 108 of screen display window 100.

In one embodiment, the delivery speed may be a factor in determining a display duration for each text grouping. A longer display duration results in a slower delivery speed, while a shorter display duration results in a faster delivery speed. The display duration is the length of time a present text grouping is displayed in display area 108 before being replaced by a subsequent text grouping.

FIG. 2 illustrates another exemplary screen display window 200 for the text player application, according to another embodiment of the present invention. Screen display window 200 includes user settable controls that enable a user to adjust one or more factors that may be considered in determining the display duration and a user selectable control that determines the size of a text grouping. As depicted, screen display window 200 comprises a delay-minor control 202, delay-major control 204, text delay time control 206, and a number of words selection box 208.

Delay-minor control 202 generally functions to control a delay that may be associated with and provided for “minor” punctuation marks (e.g., semi-colon, comma, etc.). If a current text grouping displayed in display area 108 includes a minor punctuation mark, the text player application may extend the display duration for the particular text grouping. The position of delay-minor control 202 determines the extent of time the display duration is extended due to the presence of the minor punctuation mark. For example, positioning delay-minor control 202 to the left reduces the display duration extension amount, while positioning delay-minor control 202 to the right increases the display duration extension amount.

For example, display area 108 (FIG. 2) displays a present text grouping “well,” that includes a minor punctuation mark (e.g., a comma). The present text grouping “swell,” may be assigned a display duration longer than a text grouping without a minor punctuation mark, such as, by way of example, “both” (displayed in display area 108 in FIG. 1). The extent the display duration is extended is dependent on the positioning of delay-minor control 202.

Delay-major control 204 generally functions to control a delay that may be associated with and provided for “major” punctuation marks (e.g., period, colon, question mark, etc.). If a present text grouping displayed in display area 108 includes a major punctuation mark, the text player application may extend the display duration for the particular text grouping. The position of delay-major control 204 determines the extent of time the display duration is extended due to the presence of a major punctuation mark. For example, positioning delay-major control 204 to the left reduces the display duration extension amount, while positioning delay-major control 204 to the right increases the display duration extension amount.

Text delay time control 206 generally functions to incorporate a delay between the delivery of the present text grouping in display area 108 and a subsequent text grouping. For example, positioning text delay time control 206 to the left reduces the display duration of the present text grouping, while positioning text delay time control 206 to the right increases the display duration.

Number of words selection box 208 generally functions to define the size of the text grouping. As illustrated, number of words selection box 208 provides a user the ability to select “one word,” “three words,” or “contrasted three words.” The user's selection of one of the selectable options presented in number of words selection box 208 determines the number of textual elements contained in a text grouping.

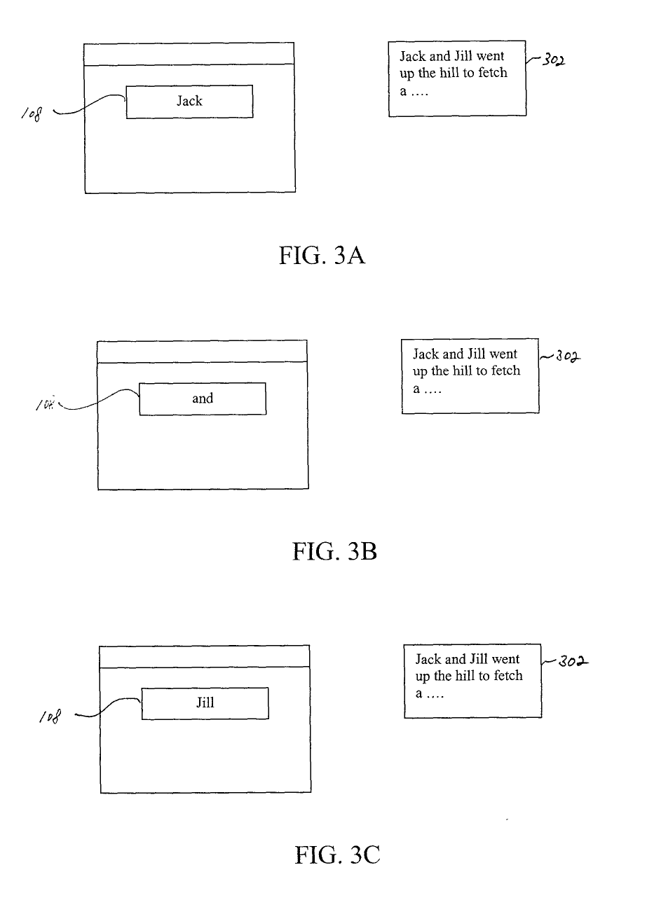

For example, if “one word” is selected, each text grouping is comprised of one textual element. FIGS. 3A, 3B, and 3C illustrate an exemplary sequence for a single textual element (e.g., single word) stacked display, according to an embodiment of the present invention. As illustrated, a document 302 contains the phrase “Jack and Jill went up the hill to fetch a . . . ” Assuming that the pointer for document 302 currently points to the textual element “Jack”, the text player application obtains the appropriate number of textual elements to form a text grouping. In this instance, a text grouping is made up of one textual element.

As illustrated in FIG. 3A, the text player application displays the text grouping “Jack” in display area 108. This is done for the appropriate display duration. Afterwards (e.g., after the currently displayed text grouping has been displayed for the appropriate display duration), the text player application generates and displays the immediately following text grouping “and” in display area 108, as illustrated in FIG. 3B. The text grouping “and” replaces the previous text grouping “Jack” in display area 108. The text player application displays the text grouping “and” for an appropriate display period, and thereafter, replaces the text grouping “and” with the immediately following text grouping “Jill” in display area 108, as illustrated in FIG. 3C.

In another embodiment, the text player application may pre-process some or all of the contents of document 302. For example, the text player application may generate a string of text groupings from the document 302 contents, and locally store the string of text groupings in memory (e.g., cache). Afterwards, the text player application may retrieve the string from memory and separately display each text grouping in sequence in display area 108. The text player application may access document 302 and generate additional strings of text groupings as necessary.

If “three words” or “contrasted three words” is selected, a text grouping is comprised of no more than three consecutive textual elements. Furthermore, if “contrasted three words” is selected, the display of the middle textual element (i.e., the current textual element) in the text grouping is contrasted from the display of the surrounding textual elements in display area 108. For example, the middle textual element may be displayed in reverse or contrasted video.

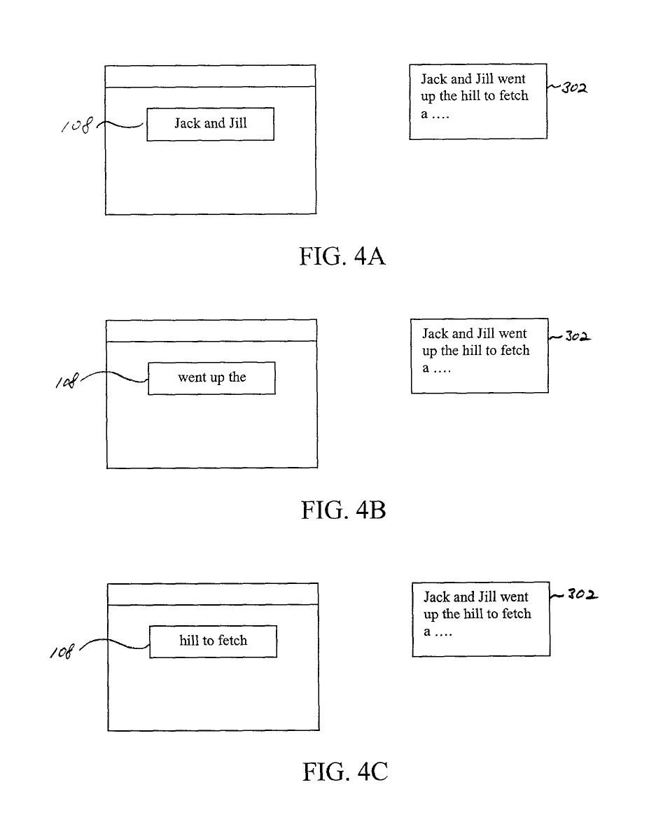

For example, if “three words” is selected, a text grouping is comprised of no more than three textual elements. FIGS. 4A, 4B, and 4C illustrate an exemplary sequence for a three-textual element (e.g., three words) stacked display, according to an embodiment of the present invention. The text player application is displaying the contents of document 302, which includes the phrase, “Jack and Jill went up the hill to fetch a . . . ”

As illustrated in FIG. 4A, the text player application displays the text grouping “Jack and Jill” in display area 108. The present text grouping “Jack and Jill” includes three textual elements “Jack,” “and,” and “Jill.” The current textual element “Jack” is the first textual element processed by the text player application. In this embodiment of the three-textual element stacked display, the current textual element (i.e., “Jack”) is in the first position. The text player application displays the present text grouping “Jack and Jill” for the appropriate display duration.

Subsequently the text player application generates and displays the immediately following text grouping “went up the” in display area 108, as illustrate in FIG. 4B. The text grouping “went up the” replaces the text grouping “Jack and Jill” in display area 108. The text player application displays the text grouping “went up the” for an appropriate display period, and afterwards, replaces the text grouping “went up the” with the immediately following text grouping “hill to fetch” in display area 108, as illustrated in FIG. 4C.

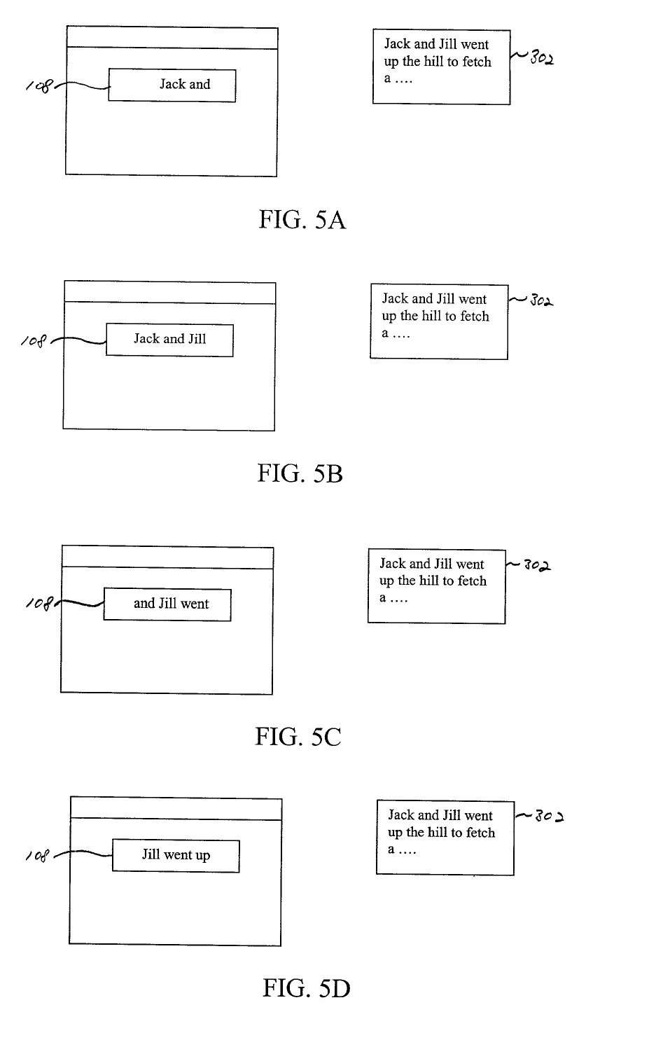

FIGS. 5A, 5B, 5C, and 5D illustrate an exemplary sequence for a three-textual element stacked display, according to another embodiment of the present invention. Again, the contents of document 302 are displayed. As illustrated in FIG. 5A, the text player application displays the text grouping “Jack and” in display area 108. The present text grouping “Jack and” includes two textual elements “Jack” and “and” instead of three textual elements. This is because the current textual element “Jack” is the first textual element processed by the text player application. In this embodiment of the three-textual element stacked display, the current textual element (i.e., “Jack”) is in the middle position. Furthermore, the text player application may position the current textual element in substantially the center of display area 108. The text player application displays the present text grouping “Jack and” for the appropriate display duration.

Subsequently the text player application generates and displays the immediately following text grouping “Jack and Jill” in display area 108, as illustrate in FIG. 5B. The text grouping “Jack and Jill” replaces the text grouping “Jack and” in display area 108. The text player application displays the text grouping “Jack and Jill” for an appropriate display period, and afterwards, replaces the text grouping “Jack and Jill” with the immediately following text grouping “and Jill went” in display area 108, as illustrated in FIG. 5C. The text player application next delivers the text grouping “Jill went up” in display area 108, as illustrated in FIG. 5D.

For each of the exemplary display sequences shown in FIGS. 3A-3C, 4A-4C, and 5A to 5D, a subsequent or following text grouping replaces a previous text grouping in display area 108. For example, a first text grouping is displayed and appears in display area 108 so that it is visible to a user. After an appropriate display duration, the first text grouping no longer appears in display area 108. A very short time later, a second text grouping is displayed and appears in display area 108 and, thus, is visible to the user. Therefore, there is no need for the user's eyes to scroll back-and-forth across display area 108 to read the textual elements comprising the text groupings. Rather, the entire text grouping is made visible at substantially the same instance in time in display area 108. The textual elements comprising the text grouping are not scrolled across display area 108.

In one embodiment, the text player application may incorporate an additional delay for a text grouping, and in particular, a current textual element in the text grouping, that exceeds a certain length. For example, if a current textual element displayed in display area 108 exceeds a certain number of characters (e.g., nine characters) then the text player application may extend the display duration of the respective text grouping. This increases the likelihood of comprehension because it is likely that longer words require a longer display duration for comprehension.

In one embodiment, the text player application may substitute and/or insert certain characters or symbols into the text grouping to increase readability. For example, when the text player application reaches the end of a sentence, it may indicate the end-of-sentence by inserting a symbol, for example, a colored square, into the last text grouping for the sentence. The colored square is readily detectable by a user as the text groupings are presented in display area 108. In like manner, the text player application may insert other, readily detectable symbols to indicate, for example, the end of a paragraph, the end of a chapter, the end of a page, and the like. The text player application may provide the user with an option to activate and deactivate this feature, and also the ability to selected the visual symbols that are displayed.

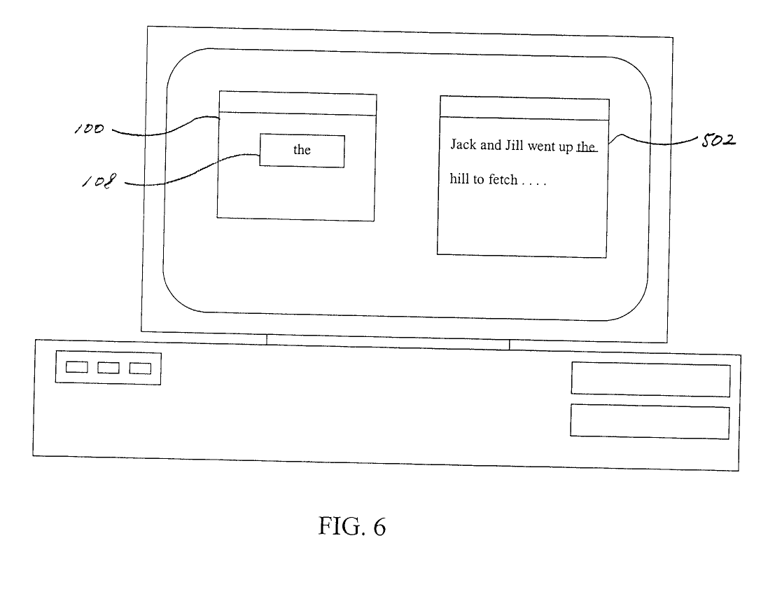

In one embodiment, the text player application may provide a user with the option to receive the contents of a document in the stacked manner as well as view the document's contents through a conventional display. FIG. 6 illustrates an exemplary stacked display and an associated conventional display, according to an embodiment of the present invention. As illustrated, the text player application delivers the contents of a document through screen display window 100 in the stacked manner. At the same time, the text player application may display a portion, up to all, of the document's contents in a separate display window 502. As the sequence of text groupings are displayed in display area 108, display window 502 may display the document's contents surrounding the particular text grouping that is presently displayed in display area 108.

For example, as is illustrated in FIG. 6, the text grouping “the” is presently displayed in display area 108. Display window 502 displays the document contents “Jack and Jill went up the hill to fetch . . . ” The present text grouping is displayed by itself in display area 108 and, at the same time, displayed as part of a larger body of text in display window 502. In one embodiment, when the text player application is stopped or paused, an indicator, such as, by way of example, a pointer, a cursor, an underline, and the like, may appear in display window 502 to identify where the text player application stopped or paused processing. For example, the cursor may indicate the current position in the document. As illustrated in FIG. 6, the user may have stopped or paused the text player application while the text grouping “the” is displayed in display area 108. Here, the textual element “the” is underlined in display area 502 to identify the last or most recently processed position in the document.

One or more of the aforementioned text player application functions and features (i.e., menu selections, button icons, and other functions) may not be provided on certain computers and electronic devices. For example, a text player application with a reduced set of features/functions may be provided for execution on electronic devices having limited processing, memory, and/or display capability. Furthermore, on electronic devices that do not support a mouse, the user may configure the implemented options and features, and otherwise interact with the text player application, through, for example, key pads and function keys that are available on the particular electronic device.

As an example, a limited text player application (with reduced feature set) may be configured to execute on an electronic device such as, by way of example, a wireless phone, a pager, a personal digital assistant (PDA), and the like. The limited text player application may communicate, for example, with a remote email server. Thus, the limited text player application may deliver and display a user's email messages, for example, on his or her wireless phone's display. Here, the limited text player application may not provide the user the ability to backtrack or move forward a paragraph, or the ability to adjust punctuation delays. Moreover, the user may operate the features and options provided in the limited text player application by, for example, using a sequence of one or more keys on the wireless phone. Furthermore, the wireless phone's display may not display the entire screen display window 100, but only display area 108.

In one embodiment, the screen display 100 may be displayed on a display device such as a CRT monitor. In other embodiment, the screen display 100, or portions of the screen display 100, may be displayed on display devices, such as, by way of example, a hologram display, a “heads-up” display (e.g., the heads-up display typically used in aircraft and automobiles to display instrumentation readouts on the canopy or windshield), a wireless telephone display, and the like. The display devices may be connected to an electronic device, such as a computer, capable of executing program logic, such as the text player application. Moreover, a particular display device may only display portions of the display window 100 as disclosed herein. As used herein, “connected,” “coupled,” or any variant thereof, means any connection or coupling, either direct or indirect, between two or more elements; the coupling or connection between the elements can be physical, logical, or a combination thereof.

Text Delivery System

A text delivery system, according to one or more embodiments of the present invention, includes the hardware and software components necessary to deliver text groupings to a user in a stacked manner. As such, the text delivery system may include a computer or other electronic device, a display device, and the text player application. The text delivery system may interact (e.g., communicate) with a document source to retrieve the contents of a document for display to a user. A “document source,” which may be thought of as a “document store” or a document repository, stores or makes available one or more documents. A document source may, for example, comprise a database on a server (e.g., document source server), a file system generally provided by operating systems (e.g., Windows, Unix, etc.), and the like. Moreover, the document source may include one or more interface modules that provide access to the documents in the document source.

As used herein, the terms “system” and “server” are to be viewed as designations of one or more computers and/or modules and are not to be otherwise limiting in any manner. The computers for the text delivery system and the document source server may be the same or different. The text delivery system may, for example, be comprised of one or more modules that execute on one or more computers. The document source server need not be server based, but can generally comprise one or more modules that execute on one or more computers.

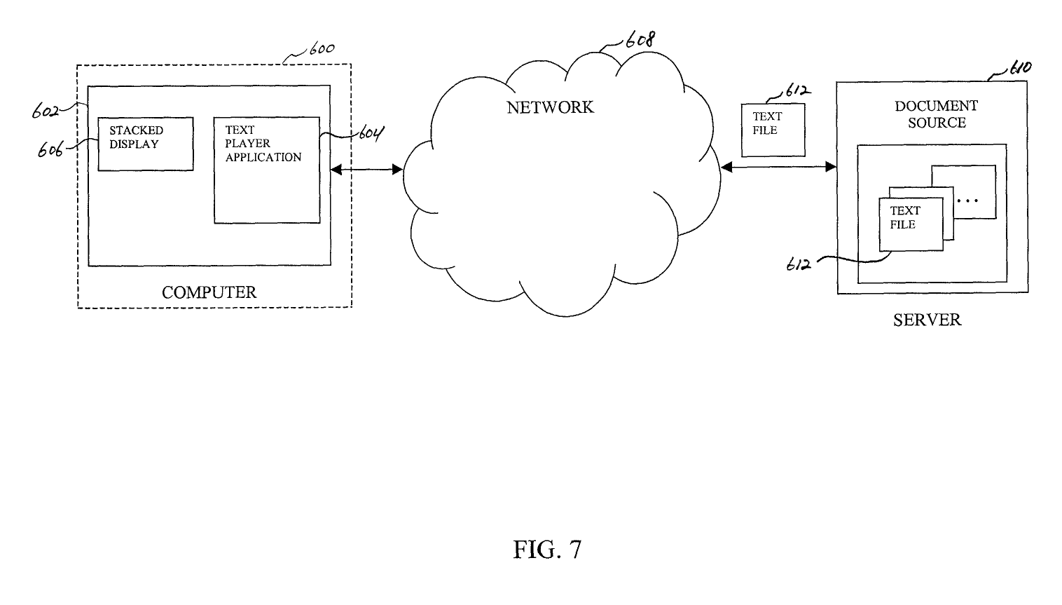

FIG. 7 illustrates an exemplary environment in which a text delivery system 600, according to an embodiment of the present invention, may operate. As shown, text delivery system 600 includes a computer 602 comprising a text player application 604 and a stacked display 606. Text player application 604 executes on computer 602 and displays the contents of a user specified document on stacked display 606. Text player application 604 may be the text player application or the limited text player application disclosed herein. Stacked display 606 may be portions of screen display window 100, and in particular, display area 108.

As depicted, the environment includes text delivery system 600, a network 608, and a document source server 610. Computer 602 of text delivery system 600 is connected to network 608. Network 608 generally functions to provide a medium for the transport of data and information between connected devices. Network 608 may be a network, such as, by way of example, the Internet, a local area network (LAN), a wide area network (WAN), a telephone network, a wireless network, a telecommunications network, a wireless telecommunications network, etc., or a combination thereof.

Document source server 610 is also connected to network 608. Document source server 610 generally functions as a document store storing one or more documents. As depicted in FIG. 6, the documents may be stored as one or more text files 612 in a document source in document source server 610. For example, text file 612 may be an email message, a transcribed voice mail message, a manuscript, a multimedia file, an essay, a story, an article, or any other compilation of characters and/or graphics. Text file 612 may be in various formats, such as, by way of example, one of the many standard operating system file formats, HTML format, script format, text format, WordPerfect® format, Microsoft Word® format, Microsoft Outlook® format, and the like.

In one embodiment, a user may specify his or her desire to receive the contents of a remotely stored text file 612 (i.e., document). The user may specify a network path name or a network address, such as, by way of example, a Universal Resource Locator (URL), that identifies document source server 610 and the desired text file 612. In response to the user's request, text player application 604 may access the specified document source server 610 over network 608 and request to obtain the contents of the desired text file 612. After receiving the request to access the contents of text file 612, the document source server 612 may transmit the contents of text file 612 over network 608 to computer 602. Text player application 604 may then locally store the received contents of text file 612, for example, in cache memory, and generate and display the text groupings in stacked display 606.

In another embodiment, text player application 604 may request to receive a portion of text file 612. For example, text player application 604 may implement a feature enabling a user to request and receive a portion of the specified text file 612. Using this feature, the user may specify, for example, through an option in screen display window 100, his or her desire to receive a particular page, paragraphs, chapter, or other segment of text file 612. Thus, this feature allows the user to choose and limit the amount of material (and associated text groupings) delivered and displayed by text player application 604.

In one embodiment, text player application 604 may segment the material (e.g., text file 612) specified by the user into one or more strings. For example, text player application 604 may access the specified document source server 610 over network 608 and request to obtain the contents of text file 612 as one or more strings. The document source server 612, after receiving the request to obtain the one or more strings, may transmit the appropriate portion of the contents of text file 612 (comprising the requested strings) over network 608 to computer 602. Text player application 604 may then locally store the received strings, for example, in cache memory, and generate and display the text groupings in stacked display 606.

In another embodiment, document source server 610 may segment the requested material (e.g., text file 612) into one or more strings. For example, text player application 604 may access document source server 610 and request a portion of or all of the contents of a particular text file 612. In response, document source server 610 may segment the requested material into a sequence of one or more strings, and appropriately transmit the sequence of strings to the requesting computer 602.

In still another embodiment, the user requested text file 612 may be stored locally on computer 602. For example, although not shown in FIG. 7, the document source containing the requested text file 612 may be on computer 602. In another example, a local copy of the requested text file 612 may be maintained on computer 602 from a previous reading of the same text file 612.

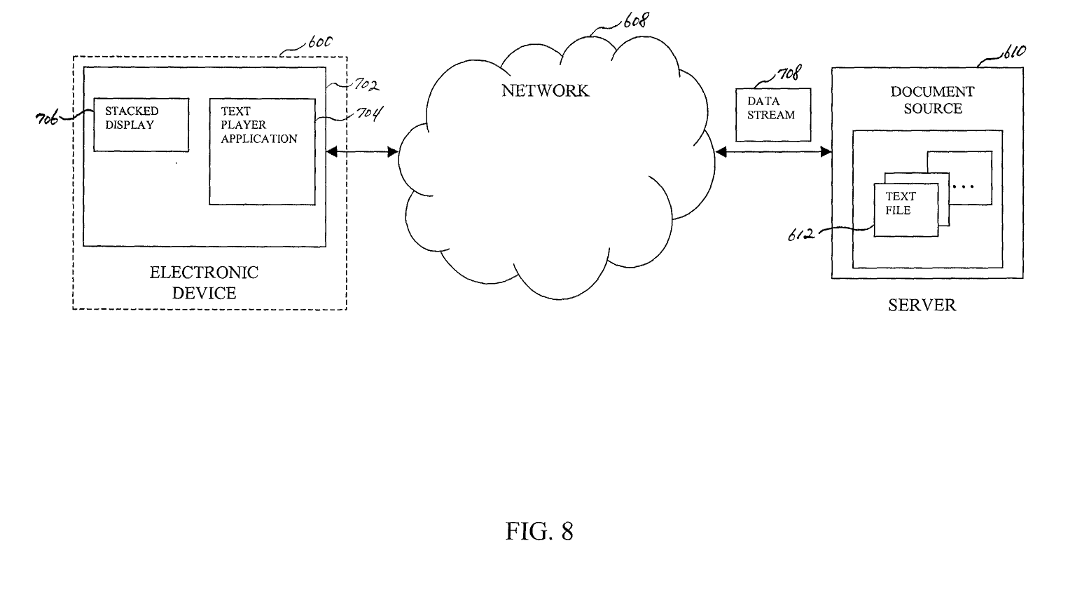

FIG. 8 illustrates another exemplary environment in which text delivery system 600, according to another embodiment of the present invention, may operate. As shown, text delivery system 600 includes an electronic device 702 comprising a text player application 704 and a stacked display 706. Text player application 704 executes on electronic device 702 and displays the contents of a user specified document on stacked display 706. Text player application 704 may be the limited text player application disclosed herein. Stacked display 706 may contain portions of screen display window 100, and in particular, portions of display area 108.

As depicted, the environment includes text delivery system 600, network 608, and document source server 610 storing one or more text files 612. Electronic device 702 is connected to network 608. Document source server 610 is also connected to network 610. In one embodiment, a user may specify his or her desire to receive the contents of a remotely stored text file 612 on document source server 610. Document source server 610 may subsequently transmit the requested text file 612 as a sequence of one or more data streams 708. Each data stream 708 may be a component of text file 612.

In one embodiment, data streams 708 represent a continuous stream of data (e.g., all or a portion of the contents of text file 612 are transmitted as a continuous stream of data). Text player application 704 may then store the data received via data streams 708 on electronic device 702 in, for example, a queue. Text player application 704 can then retrieve the data stream from one end of the queue, create a text grouping, and display the text grouping on stacked display 706.

For example, electronic device 702 may be wireless consumer device such as, by way of example, a personal digital assistant (PDA), pager, wireless phone, etc., and document source server 610 may be a paging or e-mail server. Document source server 610 may receive an e-mail or page for a user, and subsequently notify the user of the email or page on the user's electronic device 702. The user can then select the e-mail or page from a list of messages displayed on electronic device 702, and select an option to receive the e-mail or page. Electronic device 702 can then transmit the request to document source server 610, and document source server 610 can transmit the specified e-mail or page to electronic device 702 in the form of one or more data streams 708. Electronic device 702 can then store, process, and appropriately display the e-mail or page as a sequence of text groupings on stacked display 706.

Method for Text Delivery and Display

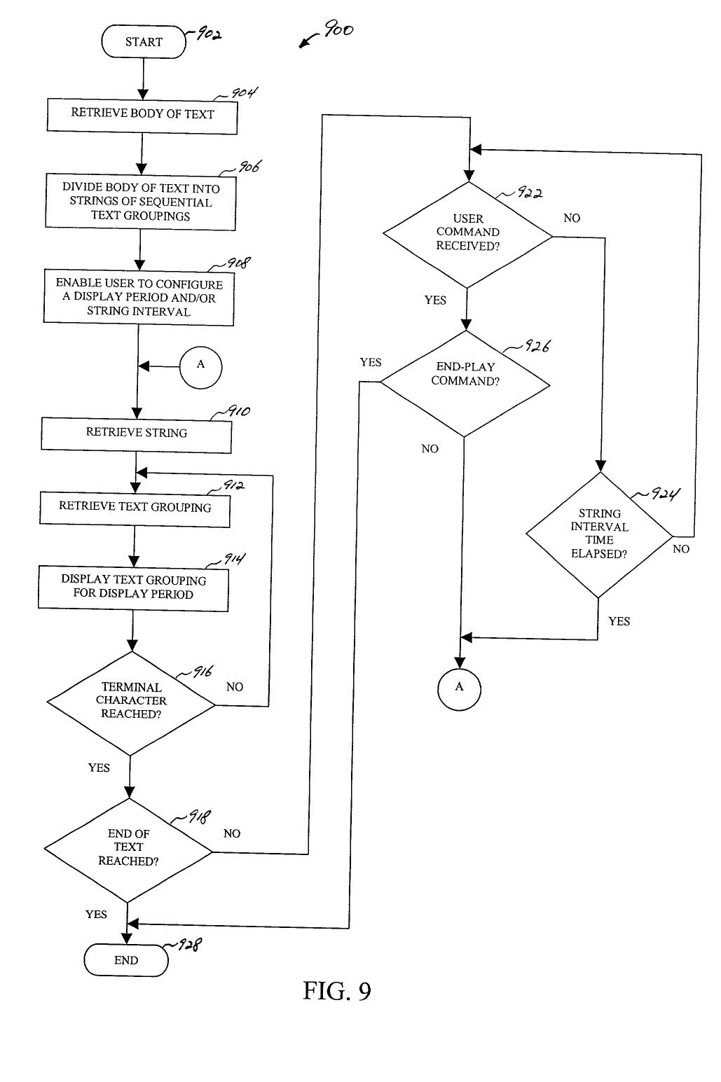

FIG. 9 is a flow chart of an exemplary method 900 for delivering and displaying text, according to an embodiment of the present invention. Beginning at a start step 902, a text player application (604 or 704) retrieves a body of text at step 904. The body of text may be the contents of a document (for example, stored as a text file 612). The text player application may execute on, and store the body of text on, for example, the user computer 602. In one embodiment, the text player application provides a user with the ability to specify a document for display. The text player application can retrieve the document contents specified by the user from, for example, document source server 610. In another embodiment, the text player application may provide a user with a list of documents from which the user can select a document for display.

At step 906, the text player application creates one or more strings from the retrieved body of text. For example, a user may have specified a page stop or a paragraph stop (e.g., the text player application is to stop the delivery of text at the end of a page or paragraph and wait for a user prompt or string interval time before continuing). Here, the text player application can create a sequence of strings from the body of text. The first string can be the first page (or paragraph), the second string can be the second page (or paragraph), and so on.

At step 908, the text player application may enable the user to configure one or more text delivery features and parameters associated with the text player application. For example, the user can specify the display speed (or display period), number of textual elements in a text grouping, display font, one or more delays, and the like. The text player application waits to receive a start or play command from the user.

At step 910, after receiving a start or play command from the user, the text player application retrieves a string to process. In one embodiment, the text player application may store the string, for example, in cache memory for fast access and retrieval. At step 912, the text player application determines the size for each text grouping, and creates or retrieves a first text grouping for the string. At step 914, the text player application displays the retrieved text grouping in display area 108 of screen display window 100 for the display period. In one embodiment, the text player application determines the size of the text grouping (e.g., the number of textual elements in a text grouping) based on the user's input to number of words selection box 208 (FIG. 2). In another embodiment, the text player application can deliver an audible representation of the text grouping through a speaker coupled to user computer 602 or other electronic device.

At step 916, the text player application determines if a terminal character is reached. In one embodiment, the text player application checks for the terminal character after the text grouping has been displayed in display area 108 for the appropriate display period. The text player application may determine if a terminal character is currently displayed as part of the current text grouping or textual element in display area 108. For example, the terminal character may be the end of the current string being processed by the text player application. If the terminal character has not been reached at step 916, the text player application returns to step 912 to process (e.g., generate or retrieve) the next text grouping in the string.

If the terminal character has been reached at step 916, the text player application determines if the end of text has been reached at step 918. In one embodiment, the text player application checks to see if all of the strings in the body of text retrieved at prior step 904 have been processed. If the end of text is reached, the text player application ends at step 928. In one embodiment, the last text grouping remains displayed in display area 108. If the end of text is not reached, the text player application determines if a user command is received at step 922. If a user command is not received, the text player application determines if the string interval time has elapsed at step 924. That is, in one embodiment, the text player application enables the user to specify one or more string intervals (e.g., a stop interval). For example, the user may specify a time interval the text player application is to wait upon reaching an end of string (e.g., end of sentence, paragraph, page, chapter, etc.) and before processing the next string. If the string interval time has elapsed, the text player application returns to step 910 to process the next string in the body of text. If the string interval time has not elapsed, the text player application returns to step 922 where it determines whether a user command has been received.

If, at step 922, the text player application received a user command, the text player application determines if the user command is an end-play command at step 926. End-play commands may be, by way of example, a stop command, a pause command, an exit command, etc. If an end-play command is received, the text player application ends at step 928. In one embodiment, the text player application may save the state of the document processing before it stops executing. For example, the text player application may identify the last textual element processed, the current user settings and parameters for the text player application, and the like.

If, at step 926, the user command was not an end-play command, the text player application resumes processing the next string at step 910. The user may have prompted the text player application to continue processing the next string by, for example, hitting a key on a keyboard or electronic device.

Those of ordinary skill in the art will appreciate that, for this and other methods disclosed herein, the functions performed by the exemplary flow charts may be implemented in differing order. Furthermore, steps outlined in the flow charts are only exemplary, and some of the steps may be optional, combined into fewer steps, or expanded into additional steps without detracting from the essence of the invention.

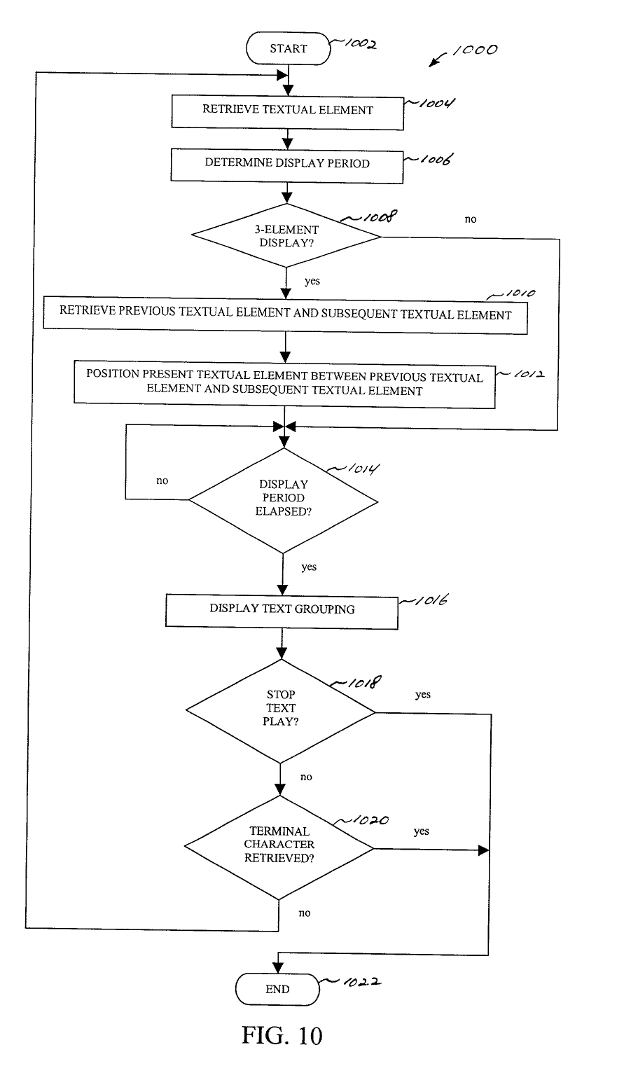

FIG. 10 is a flow chart of an exemplary method 1000 for delivering and displaying text, according to an embodiment of the present invention. Beginning at a start step 1002, a text player application (604 or 704) retrieves a textual element at step 1004. For example, the textual element may be the next word to process in a document specified by a user. At step 1006, the text player application determines the display period for the retrieved textual element. The text player application may consider factors, such as, by way of example, the length of the textual element, punctuation marks, re-read settings, and the like, in determining the display period for the retrieved textual element.

At step 1008, the text player application determines if the user specified, for example, a three-element display. The user may specify the size of the text grouping by using number of words selection box 208 (FIG. 2). If the user specified a three-element display at step 1008, the text player application retrieves the previous textual element and the subsequent textual element at step 1010. For example, the previous textual element is the present textual element component of the present text grouping being displayed in display area 108 of screen display window 100. The subsequent textual element is the textual element immediately following or subsequent to the textual element retrieved at prior step 1004.

At step 1012, the text player application positions the current textual element (i.e., the textual element retrieved at step 1004) between the previous textual element and the subsequent textual element. Thus, in a three-element display, the current or present textual element is positioned to appear substantially in the middle of display area 108 in between the previous textual element and the subsequent textual element. The three textual elements comprise the next text grouping that is to be displayed in display area 108. If, at prior step 1008, the three-element display option is not specified, the next text grouping comprises the current textual element only.

At step 1014, the text player application determines if the display period or duration associated with the presently displayed text grouping has elapsed. If the presently displayed text grouping has been displayed for the appropriate display period, the text player application displays the newly created text grouping in display area 108 at step 1016. The text player application identifies the newly created text grouping as the present text grouping and the current textual element component of the newly created text grouping as the present textual element.

At step 1018, the text player application determines if a stop command is received. For example, the text player application can check to see if it receives a command, such as, by way of example, stop, pause, or exit from the user. If a stop command is received at step 1018, the text player application ends at step 1022. Otherwise, if a stop command is not received, the text player application determines if it has retrieved a terminal character (e.g., period, paragraph break, page break, end of file, etc.) at step 1020. If a terminal character was retrieved at step 1020, the text player application ends at step 1022. On the other hand, if a terminal character was not retrieved, the text player application continues processing the next textual element at step 1004.

In one embodiment, the terminal character identifies the amount of textual elements the text player application is to deliver and display through screen display window 100. For example, the user may have specified a desire to receive the contents of the document. Here, the terminal character is the end of document or end of file character, and the text player application continues processing until specifically prompted to stop (step 1018) or the end of document character is retrieved (step 1020).

As described herein, the present invention in at least one embodiment allows for the reading of text without having to follow a progression of words across a screen (from left to right, and top to bottom). In one embodiment, a user-configurable text delivery system delivers the text contained in a document to the user in a stacked manner. A text player application of the text delivery system is user-configurable to deliver and display a first text grouping from the document for a respective display duration in a screen display window. After the display duration, another text grouping from the document replaces the first text grouping in the screen display window and is displayed for its respective display duration. The respective display duration may be determined from one or more user-configurable parameters. Thus, a user viewing the delivery of text on the screen display window is able to receive and read the text without having to move his or her eyes. This enables faster, more efficient reading. Furthermore, a user can receive and comprehend a substantial amount of data/information with a relatively limited display area because only a small text grouping is presented on the display at any given time.

In at least one embodiment, the present invention enables a user to tune the delivery and display of the text contained in a document based on the subject matter of the document. This permits the user to receive the stacked display of text at a speed comfortable for the user. For example, the user is able to tune the delivery speed to match his or her perceived reading speed to maximize comprehension and/or memory retention of the text in the document.

Furthermore, the present invention, in at least one embodiment, may permit a user to identify and review certain text in a document at a different speed or tempo than the remaining text in the document. The user can identify certain portions of text in the document and select an option for the text player application to deliver the identified text at a slower speed. Thus, the user receives the identified text in a stacked manner at a speed that greatly enhances the user's comprehension of the identified text.

This invention may be provided in other specific forms and embodiments without departing from the essential characteristics as described herein. The embodiments described above are to be considered in all aspects as illustrative only and not restrictive in any manner. The following claims rather than the foregoing description indicate the scope of the invention.

What is claimed is:

1. A method for displaying text comprising:
accessing a document comprising a body of text interspersed with terminal characters and which can be separated into a sequence of text groupings;
retrieving an initial text grouping from the document;
setting the initial text grouping as a present text grouping;
displaying the present text grouping to a user for a respective display duration, wherein the display duration is configurable by the user;
responsive to not retrieving a terminal character, retrieving an immediately subsequent text grouping from the document;
setting the immediately subsequent text grouping as the present grouping; and
repeating the displaying the present text grouping, retrieving an immediately subsequent text grouping, and setting the immediately subsequent text grouping until a terminal character is retrieved.

2. The method of claim 1, wherein each text grouping consists of one to three textual elements.

3. The method of claim 1, wherein the terminal character is dependent on a user command.

4. The method of claim 1 further comprising displaying the text in a text player.

5. The method of claim 1, wherein the terminal character comprises an end of sentence.

6. The method of claim 1, wherein the terminal character comprises an end of text.

7. The method of claim 1, wherein the terminal character comprises an end of page.

8. The method of claim 1, wherein the terminal character comprises an end of chapter.

9. The method of claim 1, wherein the display duration incorporates an excessive character delay.

10. The method of claim 1, wherein the display duration incorporates a minor punctuation delay.

11. The method of claim 1, wherein the display duration incorporates a major punctuation delay.

12. The method of claim 1, wherein the display duration incorporates a text delay.

13. The method of claim 1 further comprising:
receiving a forward text grouping command from the user; and
advancing to a text grouping which is not immediately subsequent to the present text grouping.

14. The method of claim 1 further comprising
receiving a backward text grouping command from the user; and
returning to a text grouping which precedes the present text grouping.

15. The method of claim 14, wherein the subsequent text grouping is a beginning textual element of a previous sentence and the user command is a back sentence command.

16. The method of claim 13, wherein the subsequent text grouping is a beginning textual element of a subsequent sentence and the user command is a forward sentence command.

17. The method of claim 14, wherein the subsequent text grouping is a beginning textual element of a previous paragraph and the user command is a back paragraph command.

18. The method of claim 13, wherein the subsequent text grouping is a beginning textual element of a subsequent paragraph and the user command is a next paragraph command.

19. The method of claim 1 further comprising:
receiving a stop command from the user; and
stopping the displaying of the present text grouping.

20. The method of claim 1, wherein the display duration is increased by an extended display factor responsive to receiving a re-read slow command.

21. The method of claim 1, wherein the immediately subsequent text grouping is retrieved responsive to receiving a forward word command from the user.

22. A method comprising:
responsive to a command received from a user, retrieving a body of text from a document, the body of text comprising a sequence of textual elements, wherein at least a portion of the textual elements are terminal characters;
dividing the sequence of textual elements into strings of sequential text groupings, wherein each string ends with a terminal character, and each text grouping comprises at least one textual element; and
for each string, separately displaying to the user for a respective display period each text grouping of the string in sequence until the terminal character of the string is reached, wherein a duration of display periods is configurable by the user.

23. A method for retrieving text for display on an electronic device, the method comprising:
receiving a data stream from a document source, the data stream comprising a body of text interspersed with terminal characters and which can be separated into a sequence of text groupings;
generating an initial text grouping from the received data stream;
setting the initial text grouping as a present text grouping;
displaying the present text grouping to a user for a respective display duration on an electronic device's display;
responsive to not receiving a terminal character, generating an immediately subsequent text grouping from the data stream;
setting the immediately subsequent text grouping as the present text grouping; and
repeating the displaying the present text grouping, generating an immediately subsequent text grouping, and setting the immediately subsequent text grouping until a terminal character is received.

24. The method of claim 23 further comprising receiving a user command from the electronic device, wherein the user command determines the terminal character.

25. The method of claim 23, wherein the display duration is configurable by the user.

26. The method of claim 23 further comprising delivering an audible representation of the present text grouping through at least one speaker coupled to the electronic device.

27. A text delivery system comprising a text player operable to retrieve a text grouping from a document source and display the text grouping in a display for a respective display duration configurable by a user, the text player further operable to, in response to not retrieving a terminal character, retrieve an immediately subsequent text grouping from the document source and display the immediately subsequent text grouping in the display for a respective display duration by replacing the previously displayed text grouping.

28. The system of claim 27, wherein the text player and document source are remotely located.

29. The system of claim 27, wherein the display and the text player are remotely located.

30. The system of claim 27, wherein the display is on an electronic device.

31. The system of claim 27, wherein the display comprises a hologram display.

32. The system of claim 27, wherein the display comprises a “heads-up” display.

33. A computer-readable storage medium having stored thereon computer instructions that, when executed by a computer, cause the computer to:
access a document comprising a body of text interspersed with terminal characters and which can be separated into a sequence of text groupings;
retrieve an initial text grouping from the document;
set the initial text grouping as a present text grouping;
display the present text grouping to a user for a respective display duration, wherein the display duration is configurable by the user;
in response to not retrieving a terminal character, retrieve an immediately subsequent text grouping from the document;
set the immediately subsequent text grouping as the present text grouping; and
repeat the display the present text grouping; retrieve an immediately subsequent text grouping, and set the immediately subsequent text grouping until a terminal character is retrieved.

34. A computer-readable storage medium having stored thereon computer instructions that, when executed by a computer, cause the computer to:
in response to a user command, retrieve a body of text from a document, the body of text comprising a sequence of textual elements, wherein at least a portion of the textual elements are terminal characters;
divide the sequence of textual elements into strings of sequential text groupings, wherein each string ends with a terminal character, and each text grouping comprises at least one textual element; and
for each string, separately display to a user for a respective display period each text grouping of the string in sequence until the terminal character of the string is reached, wherein a duration of display periods is configurable by a user.

35. A text player system comprises computer instructions that, when executed by a computer, cause the computer to:
receive a data stream from a document source, the data stream comprising a body of text interspersed with terminal characters and which can be separated into a sequence of text groupings;
generate an initial text grouping from the received data stream;
set the initial text grouping as a present text grouping;
display the present text grouping to a user for a respective display duration on an electronic device's display;
responsive to not receiving a terminal character, generate an immediately subsequent text grouping from the data stream;
set the immediately subsequent text grouping as the present text grouping; and
repeat the display of present text grouping, generate an immediately subsequent text grouping, and set the immediately subsequent text grouping until a terminal character is received.
